(19) United States
(12) Patent Application Publication
(10) Pub. No.: US 2002/0153296 A1
(43) Pub. Date: Oct. 24, 2002

(54) Arrangement for fastening filter cloth to solid-liquid separator

(76) Inventors: Matti Servo, Tampere (FI); Anssi Rantala, Lempaala (FI); Vesa-Matti Riihioja, Tampere (FI)

Correspondence Address: MCDERMOTT WILL & EMERY, 600 13TH STREET, N.W., WASHINGTON, DC, 20005-3096, US

(21) Appl. No.: 09/836,546

(22) Filed: Apr. 18, 2001

(51) Int. Cl. B01D 33/21

(52) U.S. Cl. 210/232; 210/324

(57) ABSTRACT

A fastening strip for fastening a filter cloth against the filter surface of a solid-liquid separator. The solid-liquid separator comprises at least one filter element provided with a fastening groove for the fastening strip. The filter cloth is fastened to the filter element by means of the fastening strip, whose fastening portion is inserted into the fastening groove. The fastening strip is an elongated piece having a substantially T-shaped cross section and comprising a fastening portion and a support portion transverse to the fastening portion. The support portion provides a protective edging that extends to a distance from the edges of the fastening groove.

### FIELD OF THE INVENTION

The invention relates to a fastening strip for fastening a filter cloth against the filter surface of a solid-liquid separator filter element. The filter element comprises a fastening groove, in which the fastening strip is arranged. The invention further relates to a filter unit in a solid-liquid separator, the filter unit comprising a filter element and a filter cloth, and a fastening strip for joining them together.

### BACKGROUND OF THE INVENTION

Solid-liquid separators are used for separating liquid and solids from a mixture of solids and liquid. Solid-liquid separators include disc and drum filters, for example. FIG. 1 shows the former. A disc filter 1 typically comprises several substantially triangular sector elements (blades) 2, fastened at joint faces provided in their neck portions 3 to a rotary body 4 of the disc filter. In this case, adjacent sector elements form a disciform (disc-shaped) structure around a tubular body. Each sector element is hollow and flank surfaces serving as its filter surfaces are provided with holes. Onto the sector element is arranged a filter bag made from filter cloth and serving as a filtering layer. The filter disc is rotated in direction A around the horizontal axis of the body portion in a basin 5 containing a mixture 6 of solids and liquid. During the filtration stage, when the sector element is submersed in the mixture in the basin, suction acts inside the sector element, whereby the liquid in the mixture penetrates the filter cloth and is allowed inside the sector element through the holes on the filter surface. The liquid is led from the sector element along a flow duct in the neck portion of the sector element to the tubular body of the disc filter for further processing. During filtration, solids adhere to the filter cloth in the flank surfaces of the sector elements. Before the next filtration step, the solids cake has to be discharged, and a pressure pulse is therefore applied to the inside of the sector element, the pressure pulse releasing the solids cake from the surface of the filter cloth. The released solids are led by means of doctor blades or corresponding cleaning surfaces to a discharge chute 26 from both flank surfaces of the disc.

The filter cloth to be arranged onto the sector elements of the disc filter is usually designed in advance as a cylindrical tube corresponding to the shape of the sector element and it comprises an open narrower end, i.e. a first end, and an open wider end, i.e. a second end. Such a filter bag is arranged in place by pulling it via the neck portion onto the sector element. The narrower end of the bag is then fastened around the neck portion of the sector element by means of clamping elements. The clamping element may be any known clamping element. The periphery of the sector element is provided with a fastening groove, to which the wider end of the tubular filter cloth is fastened in a first step by means of an elongated fastening strip. The fastening of the sector elements to the body portion and the fastening of the wider end of the filter cloth are then secured with a clamp 15, which is tightened around the periphery of the filter disc by means of supporting bars 30 or the like. The filter cloth is caught between the clamp and the sector element. As the fastening strip is inserted into the fastening groove of the sector element, it pushes the filter cloth along with it to the fastening groove thus sealing the end of the filter bag. The fastening strip also tightens the filter cloth arranged around the sector element against the sector element. A presently used fastening strip is for example a rope or a bar made from flexible material, such as rubber, which is hammered into the fastening groove with a hammer. The cross section of the fastening strip is round, which makes it difficult to aim hammer blows at the curved outer surface of such a strip. Hammer blows very typically also hit the structure of the sector element, damaging the sector element that is made from plastic or corresponding material. Furthermore, missed blows may damage the filter cloth. A further drawback in the prior art is that, during the discharge of the cake, the filter bag expands against the sharp edges of the clamp. A continuous reciprocating movement causes scuffing, which wears the filter cloth.

### SUMMARY OF THE INVENTION

The object of the present invention is to provide a novel and improved arrangement for fastening a filter cloth to a solid-liquid separator.

The invention relates to a fastening strip for fastening a filter cloth to the filter element of a solid-liquid separator, wherein the solid-liquid separator comprises a body portion rotatable around its horizontal axis, two or more adjacent filter elements arranged on the periphery of said body portion, each filter element comprising at least one filter surface provided with holes, against which surface the filter cloth is arranged, and at least one fastening groove arranged in connection with the filter element, in which groove the fastening strip is to be arranged for fastening the filter cloth; the fastening strip is an elongated piece having a substantially T-formed cross section and comprising; a fastening portion made from flexible material and so dimensioned that it is deformed when inserted into said fastening groove and generates a fastening force; and a support portion that is transverse to the fastening portion and remains outside the fastening groove and is dimensioned so as to extend to a predetermined distance from the edge of the fastening groove.

The invention also relates to a filter unit for a disc filter, wherein: the disc filter comprises a body portion that is rotatable around its horizontal axis and on whose periphery are arranged two or more filter units that form a disciform (disc-shaped) structure; the filter unit comprises a sector element, a filter cloth and a fastening strip; the sector element comprises a neck portion from which it can be fastened to the body portion of the disc filter, a flat substantially triangular hollow blade portion comprising an outer edge at the edge opposite to the neck portion, lateral faces transverse to the direction of rotation and flank surfaces in the direction of rotation; the flank surfaces of the sector element are provided with holes and act as filter surfaces; the filter cloth is arranged against said filter surfaces and the sector element comprises at least one fastening groove, wherein a fastening strip is to be arranged for fastening the filter cloth to the sector element; the fastening strip is an elongated piece having a substantially T-formed cross section and comprising: a fastening portion made from flexible material and so dimensioned that it is deformed when inserted into said fastening groove and generates a fastening force; and a support portion that is transverse to the fastening portion and remains outside the fastening groove and extends to a predetermined distance from the edge of the fastening groove.

The invention further relates to a drum filter comprising a body portion, which is an elongated tubular piece rotatable around its horizontal axis, a plurality of adjacent filter elements arranged on the periphery of the body portion, the filter elements comprising hollow spaces substantially in the shape of a toroidal sector in the longitudinal direction of the body portion, the periphery of the filter elements being provided with holes, and the outer peripheries of adjacent filter elements together forming the filter surface of the drum filter, one or more fastening grooves provided on the periphery of the drum filter, a filter cloth fastened by means of one or more fastening strips to said one or more fastening grooves, the filter cloth being arranged against the filter surface of the drum filter, and wherein the fastening strip is an elongated piece having a substantially T-formed cross section and comprising a fastening portion made from flexible material and so dimensioned that it is deformed when inserted into said fastening groove and generates a fastening force, and a support portion that is transverse to the fastening portion and remains outside the fastening groove and extends to a predetermined distance from the edge of the fastening groove.

The essential idea of the invention is that a liquid-solid separator filter element comprises or has in association therewith one or more fastening grooves for a fastening strip. A filter cloth serving as a filtering layer is arranged against the perforated filter surface of the filter element, whereupon it is tightened and fastened in place by means of the fastening strip. The fastening strip is an elongated piece having a substantially T-formed cross section and comprising a fastening portion that is inserted into the fastening groove, and a support portion that is transverse to the fastening portion and remains outside the fastening groove, on both sides thereof. At least the fastening portion of the fastening strip is made from flexible material so as to allow the fastening portion to be deformed to some degree when inserted into the fastening groove and thus produce a fastening force, which, together with friction, keeps the fastening strip firmly in place in the fastening groove of the filter element. The support portion of the fastening strip settles substantially in the direction of the surface of the filter element and extends to a predetermined distance from the edge of the fastening groove.

An advantage of the fastening strip of the invention is that it is easier to install than prior art fastening strips. The support portion of the fastening strip protects the filter element and the filter cloth from blows and other damage during installation. Furthermore, the support portion of the fastening strip dampens the movements of the filter cloth resulting from the changes in the pressure acting inside the filter element. This prevents scuffing of the filter cloth and the resulting wear.

The essential idea of a preferred embodiment of the invention is that at least the lower surface of the support portion of the fastening strip is curved, whereby the support portion settles against the curved outer surface of the filter element.

The essential idea of a second preferred embodiment of the invention is that the support portion of the fastening strip is made from flexible material and that the support portion narrows from the middle portion towards the edges, whereby the edges of the support portion are flexible.

The essential idea of a third preferred embodiment of the invention is that the upper surface of the support portion of the fastening strip comprises a substantially flat surface in the middle portion of the support portion. Hammer blows are substantially easier to aim at this so-called hammering surface during installation of the fastening strip.

### BRIEF DESCRIPTION OF THE FIGURES.

FIG. 1 is a schematic side view of a typical disc filter.

FIG. 2 is a schematic side view of a filter unit of a disc filter.

FIG. 3 is a schematic sectional view of the filter unit of FIG. 2, seen from direction B.

FIG. 4 is a schematic side view of another filter unit of a disc filter.

FIG. 5a is a schematic view of a sector element of the filter unit of FIG. 4, seen from direction B.

FIG. 5b is a schematic view of the filter bag of the filter unit of FIG. 4, seen from direction B.

FIG. 6 is a schematic end view of a fastening strip according to one embodiment of the invention before it is installed in the fastening groove of a sector element.

FIG. 7 is a schematic end view of a fastening strip according to another embodiment of the invention installed in the fastening groove of a sector element.

FIG. 8 schematically shows an application of a fastening strip of another embodiment of the invention.

FIG. 9 schematically shows a drum filter, in which the filter cloth is fastened by means of a fastening strip of the invention.

FIG. 10 is a schematic end view illustrating the fastening of a filter cloth to the filter surface of the filter elements of a drum filter according to an embodiment of the invention.

FIG. 11 is a schematic end view of illustrating another embodiment for fastening a filter cloth to a drum filter.

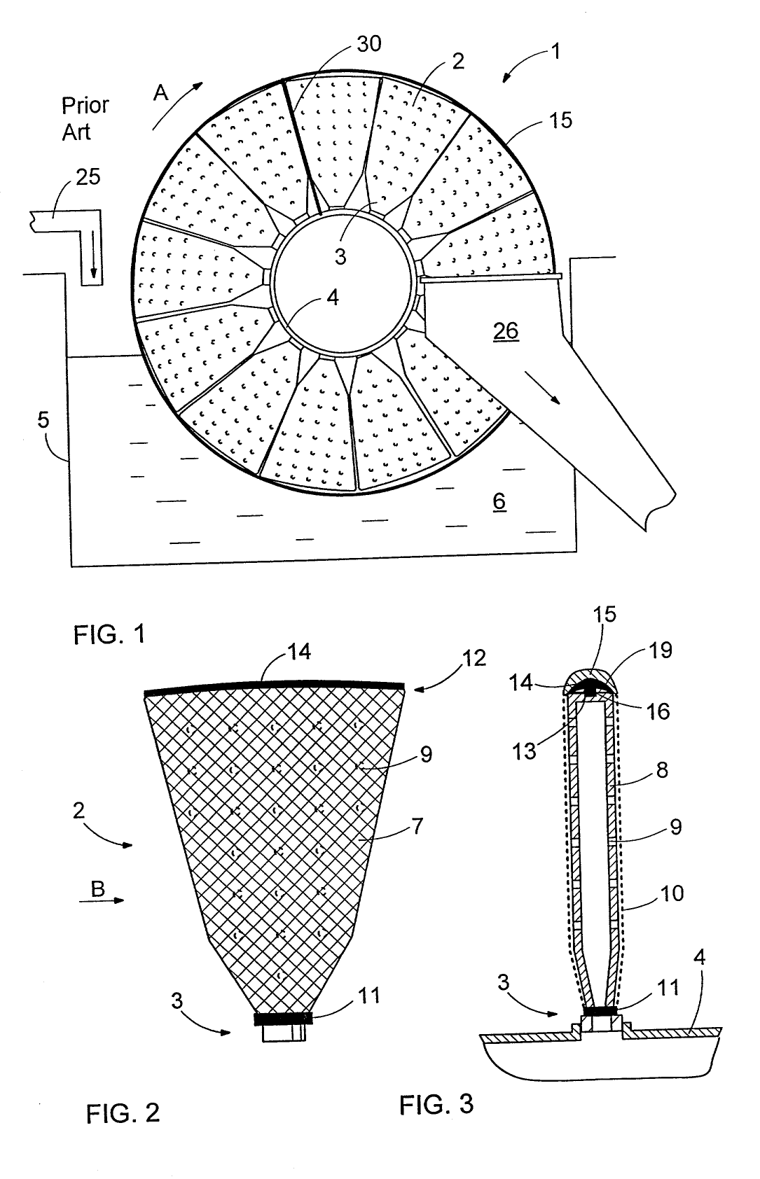

The figures are simplified views of the invention. Like reference numbers are used for like parts.

### DETAILED DESCRIPTION OF THE INVENTION

FIGS. 2 and 3 show a filter unit of a disc filter. The filter unit comprises a sector element 2 comprising a neck portion 3 and a flat substantially triangular blade portion 7. The sector element 2 is hollow, and flank surfaces 8 in its blade portion 7 comprise holes 9 through which filtered liquid, that has penetrated a filter cloth 10, is allowed inside the sector element 2. The filter cloth 10 is pre-formed as a bag corresponding to the shape of the sector element 2, both ends of the bag being open to allow the bag to be pulled onto the triangular sector element 2 via the neck portion 3 when the sector element 2 is detached from the body portion 4 of the filter. The narrower end of the bag is sealed tightly against the neck portion 3 of the sector element. A known fastening element 11 is used to seal the bag by pressing the mouth portion of the bag tightly against the neck portion 3. The edge opposite to the neck portion, i.e. a periphery 12 of the sector element 2, is provided with a fastening groove 13 in which the edges of the wider end of the filter bag are arranged and locked in place by means of an elongated fastening strip 14 to be placed in the fastening groove. The fastening strip 14 is preferably a uniform piece equal in length to the outer edge of the sector element and has a cross section that comprises a fastening portion 16 to be inserted into the fastening groove 13 and a support portion 19 that is transverse to the fastening portion and settles in the direction of the periphery of the sector element. The fastening groove 13 is dimensioned slightly narrower than the fastening portion 16 of the fastening strip 14. Therefore, the fastening portion 16 is deformed when inserted in place into the fastening groove 13. The fastening portion 16 is made from flexible compressible material or alternatively it comprises a flexible portion acting as a spring when being installed in place. The deformation of the fastening portion produces a fastening force that keeps the fastening strip and the filter cloth in place in the fastening groove. FIG. 3 shows a clamp 15, arranged around the filter disc, for securing the fastening of the filter units.

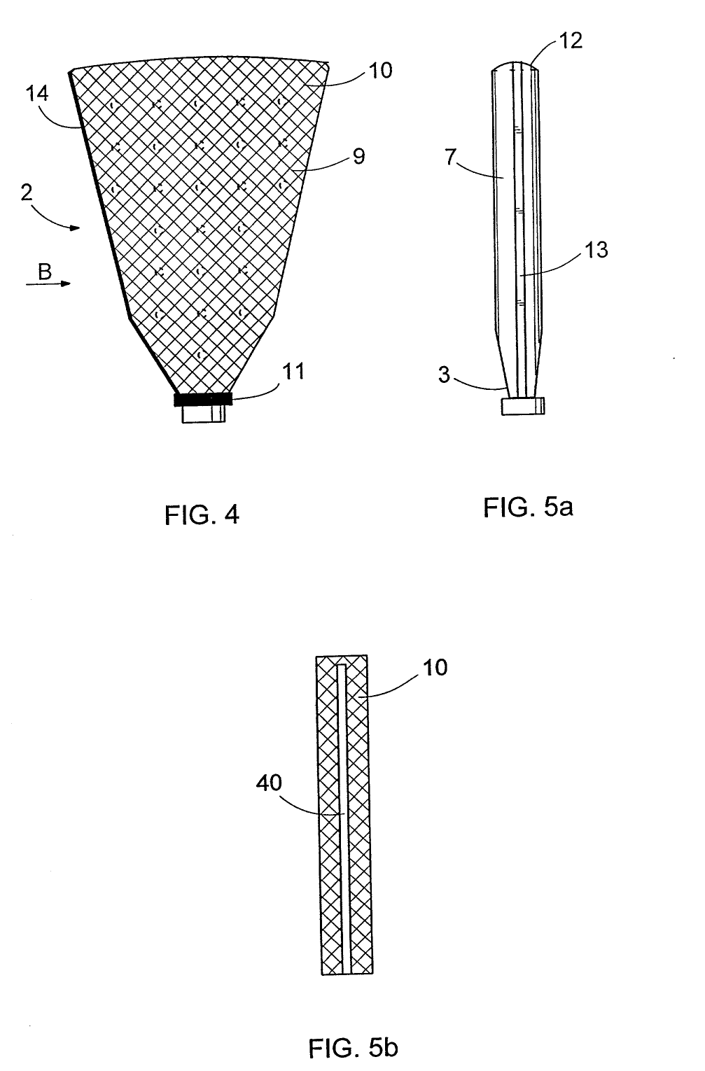

Alternatively, in accordance with FIG. 4, a substantially triangular filter bag 10 is arranged around the sector element 2, the wider end of the filter bag being closed and the narrower end open. In this embodiment, at least one side of the filter bag is provided with an opening 40 shown in FIG. 5b, from which it can be laterally arranged onto the sector element 2. Further, at least one lateral face of the sector element transverse to the direction of rotation A is provided with a fastening groove 13 shown in FIG. 5a, extending from the periphery 12 of the sector element to the neck portion 3 for the fastening strip 14, The opening 40 at the side of the filter bag 10 is closed by sealing the edges of the opening to the fastening groove 13 by means of the fastening strip 14. The narrower end of the filter bag 10 is sealed against the neck portion 3 in a conventional manner by means of suitable fastening elements 11. This solution replaces arrangements wherein the opening at the side of the filter bag is provided with a zipper or the like.

An advantage of this embodiment of the invention is that the filter bag is simpler and less expensive than prior art filter bags. Furthermore, in this embodiment of the invention, the filter bag can be tightly fastened onto the sector element upon installation. A support portion 19 in the fastening strip 14 arranged in the fastening groove 13 at the lateral faces of the sector element 2 remains between the lateral faces of the adjacent sector elements, and this ensures that the fastening strip remains in the fastening groove. In addition, the support portion 19 of the fastening strip may act between the sector elements as an element that dampens vibration.

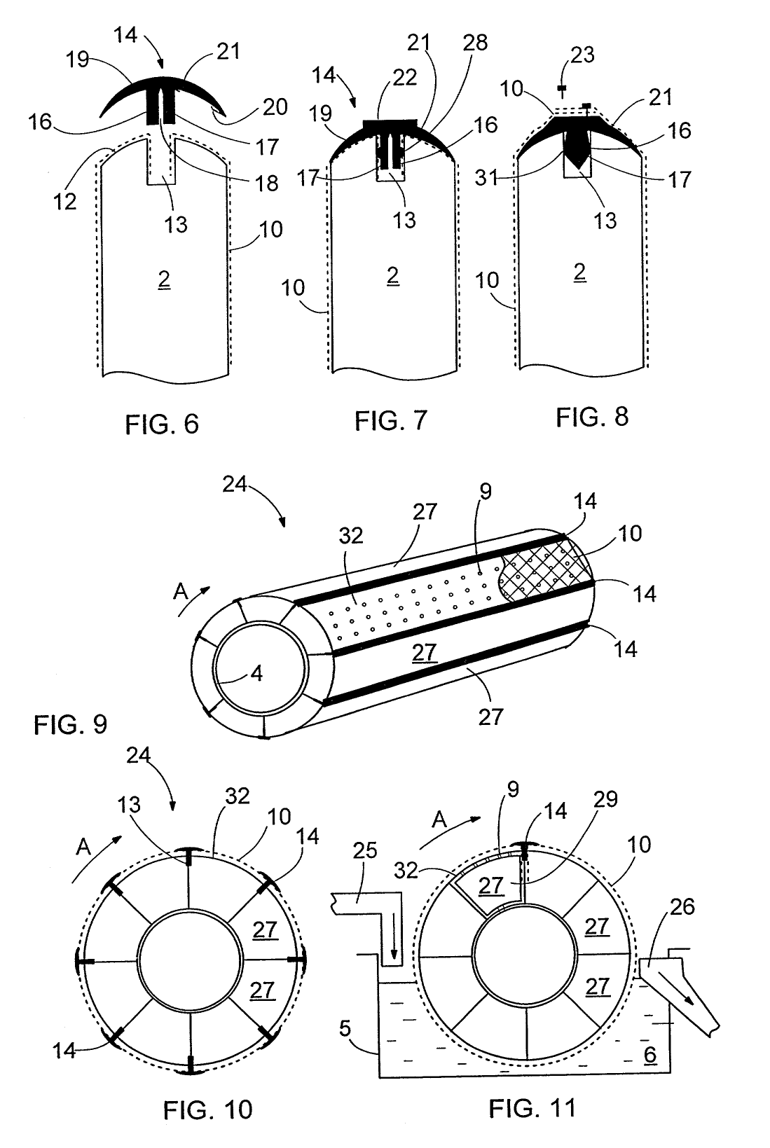

FIG. 6 shows the fastening strip 14 made, for example, by extrusion from a flexible material, such as a suitable rubber, plastic or a combination thereof. In this embodiment, the fastening portion 16 of the fastening strip 14 comprises two projections 17, between which a gap 18 forms so as to allow the projections to move towards one another when the fastening portion 16 is arranged in the fastening groove 13. A lower surface 20 in the support portion 19 of the fastening strip is curved, whereby it settles against the curved periphery 12 of the sector element. An outer surface 21 in the support portion 19 is also curved. The curvatures of the lower and upper surfaces of the support portion are preferably arranged such that the support portion 19 narrows from the middle towards its outer edges. Hereby, the edges of the support portion are flexible, allowing the filter cloth 10 to expand in a controlled manner supported by the flexible edges when a pressure pulse is applied inside the sector element 2 for discharging the solids cake. At the same time, the support portion 19 protects the filter cloth 10 and prevents it from rubbing against the clamp 15. The support portion 19 also protects the filter cloth 10 and the periphery 12 of the sector element 2 from damage upon installation. The support portion 19 is preferably so dimensioned that it substantially covers the entire periphery 12 of the sector element 2.

FIG. 7 shows an embodiment of the fastening strip 14, wherein transverse protrusions 28 are formed in the projection portions 17 of the fastening portion 16 to increase the fastening force. The upper surface 21 of the support portion 19, preferably the middle of the support portion, further comprises a flat surface 22, a so-called hammering surface, which substantially facilitates aiming the hammer blows at the fastening strip 14 during installation.

As distinct from the previous figures, FIG. 8 shows an embodiment wherein the wider edge of the filter bag is not inserted into the fastening groove 13 by means of the fastening strip 14. Instead, the fastening strip 14 is first installed in the fastening groove 13, whereupon the edges of the filter cloth 10 are folded in an overlapping manner and fastened to the upper surface 21 of the support portion 19 by means of suitable fastening elements 23, such as rivets, nails, glue or the like. In this case, the fastening strip 14 acts as an exchangeable installation base.

Another embodiment of the fastening strip 14 is shown in FIG. 8, wherein the fastening portion 16 comprises a single projection 17 with an intermediate portion 31 extending outward to contact the side walls of the fastening groove 13.

FIGS. 9, 10, and 11 are perspective views of a drum filter 24. FIG. 11 shows a basin 5, in which the filter drum is rotated around a horizontal axis during filtration. The mixture 6 to be filtered is led along a feed duct 25 into the basin and the solids cake is led from the surface of the filter to a discharge chute 26. The drum filter comprises a tubular body portion 4, on whose periphery adjacent filter elements 27 are arranged longitudinally with respect to the body portion. The cross sections of the filter elements 27 are substantially hollow spaces in the shape of a toroidal sector 29, whose peripheries 32 are provided with holes 9 and act as filtering surfaces. A filter cloth 10, acting as a filtering layer, is arranged against the filtering surface 32. Liquid that has penetrated the filter cloth 10 is allowed through the holes 9 of the filtering surface 32 inside the filter element 27 for subsequent processing. Each filter element 27 forms a separate space, inside of which suction or a pressure pulse is applied during operation, depending on whether the filter element 27 is in a filtering or a cake discharge stage.

FIG. 10 is an end view of a drum filter 24, wherein a fastening groove 13 in the direction of the longitudinal axis of the drum filter is arranged between adjacent filter elements 27. Each filter element 27 may have a separate filter cloth 10 fastened against the filter surface 30 of the filter element 27 by means of the fastening strip 14 of the invention, arranged in a fastening groove 13. Upon installation of the fastening strip 14, the fastening strip 14 pushes the longitudinal edges of the filter cloths 10 of adjacent filter elements 27 along with it into the fastening groove 13 and keeps them tightly in place.

Alternatively, the filter cloth 10 may be composed of only one piece that covers the entire periphery of the drum filter 24. In this case, the filter cloth 10 can be fastened with one fastening strip 14 as a closed loop around the drum as shown in FIG. 11. If required, a fastening strip 14 can be arranged between each adjacent filter element in accordance with FIG. 8, whereby the fastening strips 14 ensure that the filter cloth 10 remains in place and dampen any extensive expansion of the uniform filter cloth 10. The filter cloth may also be a tubular piece that is pulled onto the drum filter in the longitudinal direction of the drum filter. The tubular filter cloth is then tightly fastened, by means of fastening strips, against the filter surfaces 32 of the periphery of the drum filter.

Since the support portion 19 of the fastening strip 14 extends a distance outside the outer surface of the filter cloth 10 in the radial direction of the drum filter 24, the support portion 19 produces a discontinuity at the fastening groove 13 in the solids cake formed on the surface of filter cloth 10. At the fastening strip 14, the solids cake remains thinner, thereby breaking more easily than in prior art solid-liquid separators, when the cake is discharged. The fastening strip used in a drum filter can be of a similar type as the ones used in a disc filter.

Furthermore, each filter element 27 of the drum filter 24 may be a detachable elongated cassette, a separate filter bag being disposed around each cassette. The filter bag is an elongated tubular piece made from filter cloth, at least one end of the bag being open allowing it to be pulled longitudinally onto the filter element. In this case, in the gap between adjacent filter elements 27, a fastening strip 14 according to the invention can be arranged for tightening the filter cloth 10 tightly against the filter surface 32, thus improving the filtration result and preventing any damage to the filter cloth 10. Further, the support portion 19 of the fastening strip 14 prevents solids from penetrating in the fastening gap 13 between the filter elements, thus facilitating the discharge of the solids cake from the filter cloth 10.

The drawings and the related description are only intended to illustrate the inventive idea. The details of the invention may vary within the scope of the claims.

What is claimed is:

1. A fastening strip for fastening a filter cloth to the filter element of a solid-liquid separator, wherein
the solid-liquid separator comprises a body portion rotatable around its horizontal axis, two or more adjacent filter elements arranged on the periphery of said body portion, each filter element comprising at least one filter surface provided with holes, against which surface the filter cloth is arranged, and at least one fastening groove arranged in connection with the filter element, in which groove the fastening strip is to be arranged for fastening the filter cloth; and
the fastening strip is an elongated piece having a substantially T-formed cross section and comprising
(a) a fastening portion made from flexible material and so dimensioned that it is deformed when inserted into said fastening groove and generates a fastening force and
(b) a support portion that is transverse to the fastening portion and remains outside the fastening groove and is dimensioned so as to extend to a predetermined distance from the edge of the fastening groove.

2. The fastening strip of claim 1, wherein at least the surface on the side of the sector element of the support portion is curved.

3. The fastening strip of claim 1, wherein the support portion narrows towards the transverse edges of the fastening strip.

4. The fastening strip of claim 1, wherein the support portion comprises a flat portion on the surface opposite to the sector element.

5. The fastening strip of claim 1, wherein the fastening portion comprises two flexible projecting portions, between which is a gap that allows said projecting portions to move towards one another, the projecting portions acting as a spring.

6. The fastening strip of claim 1, wherein the fastening portion is made from flexible compressible material.

7. A filter unit for a disc filter, wherein the disc filter comprises a body portion that is rotatable around its horizontal axis and on whose periphery are arranged two or more filter units that form a disciform structure;
the filter unit comprises a sector element, a filter cloth and a fastening strip;
the sector element comprises a neck portion for fastening the sector element to the body portion of the disc filter, a flat substantially triangular hollow blade portion comprising an outer edge at the edge opposite to the neck portion, lateral faces transverse to the direction of rotation and flank surfaces in the direction of rotation;
the flank surfaces of the sector element are provided with holes and act as filter surfaces;
the filter cloth is arranged against said filter surfaces,
the sector element comprises at least one fastening groove, wherein a fastening strip is arranged for fastening the filter cloth on the sector element; and
the fastening strip is an elongated piece having a substantially T-formed cross section and comprising
(a) a fastening portion made from flexible material and so dimensioned that it is deformed when inserted into said fastening groove and generates a fastening force and
(b) a support portion that is transverse to the fastening portion and remains outside the fastening groove and extends to a predetermined distance from the edge of the fastening groove.

8. The filter unit of claim 7, wherein
the fastening groove is arranged at the outer edge of the blade portion,
a tubular filter bag that is made from filter cloth and open at both its ends, and comprises a wider end and a narrower end, is arranged around the sector element,
the narrower end of the filter bag is fastened by means of fastening elements around the neck portion of the sector element, and
the edges of the wider end of the filter bag are fastened to the fastening groove of the sector element by means of the fastening strip.

9. The filter unit of claim 7, wherein the fastening groove is arranged at least on one lateral face of the blade portion of the sector element,
a substantially triangular filter bag made from filter cloth and having a closed wider end and an open narrower end is arranged around the sector element,
the side of the filter bag comprises an opening from which the filter bag is arranged onto the sector element,
the edges of said opening are fastened by means of the fastening strip to the fastening groove at the lateral face of the blade portion, and
the narrower end of the filter bag is fastened by means of the fastening elements around the neck portion of the sector element.

10. A drum filter comprising
a body portion, which is an elongated tubular piece rotatable around its horizontal axis,
a plurality of filter elements arranged adjacent each other on the periphery of the body portion, the filter elements comprising hollow spaces substantially in the shape of a toroidal sector in the longitudinal direction of the body portion, the periphery of the filter elements being provided with holes, and the outer peripheries of adjacent filter elements together forming the filter surface of the drum filter,
one or more fastening grooves provided on the periphery of the drum filter, and
a filter cloth fastened by means of one or more fastening strips to said one or more fastening grooves, the filter cloth being arranged against the filter surface of the drum filter, and wherein
the fastening strip is an elongated piece having a substantially T-formed cross section and comprising
(a) a fastening portion made from flexible material and so dimensioned that it is deformed when inserted into said fastening groove and generates a fastening force, and
(b) a support portion that is transverse to the fastening portion and remains outside the fastening groove and extends to a predetermined distance from the edge of the fastening groove.

11. The drum filter of claim 10, wherein the fastening groove is longitudinal with respect to the body portion.

12. The drum filter of claim 11, wherein the filter cloth is a preformed tubular piece drawn onto the drum filter and tightened against the filter surface of the periphery of the drum filter by means of one or more fastening strips.

13. The drum filter of claim 11, wherein the filter cloth comprises at least one sheet-like piece arranged around the periphery of the drum filter, the longitudinal edges of the filter cloth being fastened by means of the fastening strip to the fastening groove on the periphery of the drum filter, the filter cloth forming an endless loop around the drum filter.
